(19) United States
(12) Patent Application Publication
(10) Pub. No.: US 2013/0113875 A1
(43) Pub. Date: May 9, 2013

(54) STEREOSCOPIC PANORAMA IMAGE SYNTHESIZING DEVICE, MULTI-EYE IMAGING DEVICE AND STEREOSCOPIC PANORAMA IMAGE SYNTHESIZING METHOD

(71) Applicant: FUJIFILM CORPORATION, Tokyo (JP)

(72) Inventor: Hiroyuki Ooshima, Saitama-shi (JP)

(73) Assignee: FUJIFILM CORPORATION, Tokyo (JP)

(21) Appl. No.: 13/727,490

(22) Filed: Dec. 26, 2012

Related U.S. Application Data
(63) Continuation of application No. PCT/JP2011/060947, filed on May 12, 2011.

(30) Foreign Application Priority Data
Jun. 30, 2010 (JP) 2010-149211

(51) Int. Cl. H04N 13/02

(52) U.S. Cl. CPC H04N 13/0239
USPC 348/36

(57) ABSTRACT

A method of the subject matter includes: performing projective transform of a plurality of left images and right images acquired from a plurality of stereoscopic images onto an identical projection surface separately; detecting respective corresponding points in overlapping areas between the left images and between the right images; setting a stereoscopic image in which a main subject has been detected, as a first reference stereoscopic image; with reference to the left image and the projective-transformed right image having been acquired from the first reference stereoscopic image, performing geometric deformation of adjacent left and right images such that the corresponding points between the reference left image and the adjacent left image are matched, and the corresponding points between the reference right image and the adjacent right image are matched; and synthesizing right and left panorama images based on the first reference stereoscopic images and the geometrically-deformed right and left images.

### CROSS-REFERENCE TO RELATED APPLICATIONS

This application is a PCT Bypass continuation application and claims the priority benefit under 35 U.S.C. §120 of PCT Application No. PCT/JP2011/060947 filed on May 12, 2011 which application designates the U.S., and also claims the priority benefit under 35 U.S.C. §119 of Japanese Patent Application No. 2010-149211 filed on Jun. 30, 2010, which applications are all hereby incorporated by reference in their entireties.

### BACKGROUND OF THE INVENTION

1. Field of the Invention

The presently disclosed subject matter relates to a stereoscopic panorama image synthesizing device, a multi-eye imaging device and a stereoscopic panorama image synthesizing method, and particularly to a technique of synthesizing a stereoscopic panorama image based on a plurality of stereoscopic images taken by panning the multi-eye imaging device.

2. Description of the Related Art

Conventionally, there is known a panorama image synthesizing method of imaging a sequence of images using a video camera while being fixed to a tripod or the like and rotated, combining slit images cut in a slit shape from these continuously captured images and synthesizing a panorama image (Japanese Patent Application Laid-Open No. 11-164325).

The invention described in this Japanese Patent Application Laid-Open No. 11-164325 has a feature that, by determining a slit image width based on the optical flow size between two consecutive images, cutting slit images and synthesizing these, it is possible to reliably reproduce a panorama image even in a case where angular velocity of the video camera is not constant.

Also, Japanese Patent Application Laid-Open No. 2002-366948 describes a range imaging system that can synthesize a three-dimensional space panorama.

### SUMMARY OF THE INVENTION

Although the abstract of Japanese Patent Application Laid-Open No. 11-164325 describes combining slit images cut in a slit shape from captured consecutive images and generating panorama images for the right and left viewpoints, the specification of Japanese Patent Application Laid-Open No. 11-164325 contains no description related to generation of panorama images for the right and left viewpoints.

In the invention described in Japanese Patent Application Laid-Open No. 2002-366948, a modulated electromagnetic radiation beam is irradiated to a scene and its reflection beam (image bundle formed with at least three images) is captured by a camera as a laser radar. This differs from a normal camera that does not irradiate a modulated electromagnetic radiation beam.

It is an object of the presently disclosed subject matter to provide a stereoscopic panorama image synthesizing device, a multi-eye imaging device and a stereoscopic panorama image synthesizing method that can synthesize a stereoscopic panorama image from a plurality of images taken by panning a multi-eye imaging device.

To achieve the above object, a first aspect of the presently disclosed subject matter provides a stereoscopic panorama image synthesizing device including: an image acquisition unit configured to acquire a plurality of stereoscopic images including left images and right images taken by a multi-eye imaging device, the left images and right images being taken in each imaging direction by panning the multi-eye imaging device; a storage unit configured to separate the left images and the right images from the plurality of acquired stereoscopic images and to store the left images and the right images separately; a projective transformation unit configured to perform projective transform of the plurality of stored left images and right images onto an identical projection surface separately; a corresponding point detection unit configured to detect a corresponding point in an overlapping area between the plurality of left images subjected to projective transform and to detect a corresponding point in an overlapping area between the plurality of right images subjected to projective transform; a main subject detection unit configured to detect a main subject from the plurality of stereoscopic images acquired by the image acquisition unit; a reference image setting unit configured to set a first reference stereoscopic image among the plurality of stereoscopic images and to set a stereoscopic image in which the main subject has been detected by the main subject detection unit as the first reference stereoscopic image; an image deformation unit configured, with reference to the left image and the right image subjected to projective transform in the set first reference stereoscopic image, to perform geometric deformation of an adjacent left image such that the corresponding points detected by the corresponding point detection unit between the reference left image and the adjacent left image adjacent to it are matched, and to perform geometric deformation of an adjacent right image such that the corresponding points detected by the corresponding point detection unit between the reference right image and the adjacent right image adjacent to it are matched, wherein a stereoscopic image including the left image and the right image subjected to geometric deformation is set as a next reference stereoscopic image when there are the left image and the right image subjected to projective transform that are adjacent to the left image and the right image subjected to geometric deformation, and the left image and the right image subjected to projective transform are subjected to geometric deformation as above; and a panorama synthesis unit configured to synthesize a left panorama image based on the left image of the first reference stereoscopic image and the left image subjected to geometric deformation and to synthesize a right panorama image based on the right image of the first reference stereoscopic image and the right image subjected to geometric deformation.

The stereoscopic panorama image synthesizing device according to the first aspect acquires a plurality of stereoscopic images taken by panning a multi-eye imaging device, separates left images and right images from the multiple acquired stereoscopic images and stores these separately. Subsequently, the stereoscopic panorama image synthesizing device according to the first aspect generates a left panorama image and right panorama image based on the multiple stored left images and right images, respectively. The stereoscopic panorama image synthesizing device according to the first aspect performs projective transform of the multiple stored left images and right images onto the identical projection surface to synthesize the above panorama image well, detects corresponding points of an overlapping area between the multiple left images subjected to projective transform and corresponding points of an overlapping area between the multiple right images subjected to projective transform, and performs geometric deformation such that the corresponding points between adjacent images are matched.

At this time, a stereoscopic image in which the main subject has been detected among the plurality of stereoscopic images is set as a first reference stereoscopic image, and, with reference to the left image and right image of the set first reference stereoscopic image, adjacent images to the reference images are subjected to geometric deformation. That is, the left image and right image of the reference stereoscopic image are not subjected to geometric deformation and their adjacent images are subjected geometric deformation so as to match the corresponding points of the reference image. Also, when there is an adjacent image to the image subjected to geometric deformation, using the image subjected to geometric deformation as the next reference image, and the adjacent image is subjected to geometric deformation such that the corresponding points of the adjacent image match the corresponding points of this reference image. Since the geometric deformation is performed with reference to the reference stereoscopic image as above, it is possible to synthesize a panorama image well and it is possible to prevent the stereoscopic effect of subjects in the same distance in the right and left panorama images from being changed by the imaging direction.

A second aspect of the presently disclosed subject matter is configured such that, in the stereoscopic panorama image synthesizing device according to the first aspect, in a case where the main subject has not been detected by the main subject detection unit, the reference image setting unit sets the stereoscopic image closest to the center in an imaging order among the plurality of stereoscopic images, as the first reference stereoscopic image.

According to the second aspect, it is possible to reduce the accumulated error of geometric deformation of images corresponding to both end positions of a panorama image.

A third aspect of the presently disclosed subject matter is configured such that the stereoscopic panorama image synthesizing device according to the first or second aspect further includes: a representative disparity amount acquisition unit configured to acquire a representative disparity amount of the left panorama image and the right panorama image; and a trimming unit configured to trim images of an area having a mutually overlapping effective pixel, from each of the left panorama image and the right panorama image synthesized by the panorama synthesis unit, wherein the trimming unit determines and trims a trimming area of the synthesized left panorama image and the synthesized right panorama image such that the representative disparity amount acquired by the representative disparity amount acquisition unit is a preset disparity amount.

By this means, it is possible to acquire a stereoscopic panorama image in which the disparity amount is adjusted.

The stereoscopic panorama image synthesizing device according to a fourth aspect of the presently disclosed subject matter further includes, in the first or second aspect, a trimming unit configured to trim images of an area having a mutually overlapping effective pixel, from each of the left panorama image and the right panorama image synthesized by the panorama synthesis unit.

A fifth aspect of the presently disclosed subject matter is configured such that, in the stereoscopic panorama image synthesizing device according to any of the first to fourth aspects, at a time of synthesizing the left panorama image and the right panorama image, images of an overlapping area between adjacent images are subjected to weighted average and synthesized by the panorama synthesis unit.

By this means, it is possible to smoothly synthesize connecting points of the panorama images.

The stereoscopic panorama image synthesizing device according to a sixth aspect of the presently disclosed subject matter further includes, in the third aspect, a recording unit configured to record, in a recording medium, the left panorama image and the right panorama image generated by the panorama synthesis unit in association with each other.

A seventh aspect of the presently disclosed subject matter is configured such that the stereoscopic panorama image synthesizing device according to the sixth aspect further includes a representative disparity amount acquisition unit configured to acquire representative disparity amounts of the left panorama image and the right panorama image, wherein the recording unit records, in the recording medium, the representative disparity amounts acquired by the representative disparity amount acquisition unit in association with the left panorama image and the right panorama image.

The stereoscopic panorama image synthesizing device according to an eighth aspect of the presently disclosed subject matter further includes, in the seventh aspect, an output unit configured to output the left panorama image and the right panorama image recorded in association in the recording medium, wherein the output unit relatively shifts pixels of the left panorama image and the right panorama image such that, based on the representative disparity amounts recorded in association with the left panorama image and the right panorama image, the representative disparity amounts match a preset disparity amount, and outputs the left panorama image and the right panorama image.

A ninth aspect of the presently disclosed subject matter is configured such that, in the stereoscopic panorama image synthesizing device according to the third, seventh or eighth aspect, the representative disparity amount acquisition unit acquires the representative disparity amount based on the reference stereoscopic image set by the reference image setting unit.

A tenth aspect of the presently disclosed subject matter is configured such that, in the stereoscopic panorama image synthesizing device according to the third, seventh or eighth aspect, the representative disparity amount acquisition unit includes: a corresponding point detection unit configured to detect a corresponding point per pixel of the left panorama image and the right panorama image; a disparity amount calculation unit configured to calculate a disparity amount between the detected corresponding points; a histogram creation unit configured to create a histogram of the disparity amounts calculated on a pixel-by-pixel basis; and a representative disparity amount determination unit configured to determine a representative disparity amount based on the created histogram.

As a determination method of the representative disparity amount, there is a method of determining a disparity amount in which the frequency in the histogram is peak on the nearest side, as a representative disparity amount. This is because it is considered that there is a main subject in the subject distance of this disparity amount. Also, as a representative value (representative disparity amount) of the frequency distribution of disparity amounts, the average value or median value may be used.

An eleventh aspect of the presently disclosed subject matter provides a multi-eye imaging device including: a plurality of imaging units used as the image acquisition unit; and the stereoscopic panorama image synthesizing device according to any of the first to tenth aspects.

The multi-eye imaging device according to a twelfth aspect of the presently disclosed subject matter further includes, in the eleventh aspect: a mode setting unit configured to set a stereoscopic panorama imaging mode; and a control unit configured to fix, when the stereoscopic panorama imaging mode is selected, a focus position, an exposure condition and a white balance gain of a stereoscopic image taken in every imaging direction, to a value set at a time of taking a first image.

By this means, it is possible to fix the focus position, exposure condition and white balance gain of each image for panorama image synthesis.

A thirteenth aspect of the presently disclosed subject matter provides a stereoscopic panorama image synthesizing method including: a step of acquiring a plurality of stereoscopic images including left images and right images taken by a multi-eye imaging device, the left images and right images being taken in each imaging direction by panning the multi-eye imaging device; a step of separating the left images and the right images from the plurality of acquired stereoscopic images and storing the left images and the right images separately; a step of performing projective transform of the plurality of stored left images and right images onto an identical projection surface separately; a corresponding point detecting step of detecting a corresponding point in an overlapping area between the plurality of left images subjected to projective transform and detecting a corresponding point in an overlapping area between the plurality of right images subjected to projective transform; a step of detecting a main subject from the acquired plurality of stereoscopic images; a step of setting a first reference stereoscopic image among the plurality of stereoscopic images and setting a stereoscopic image, in which the main subject has been detected, as the first reference stereoscopic image; a step of, with reference to the left image and the right image subjected to projective transform in the set first reference stereoscopic image, performing geometric deformation of an adjacent left image such that the corresponding points detected in the corresponding point detecting step between the reference left image and the adjacent left image adjacent to it are matched, and performing geometric deformation of an adjacent right image such that the corresponding points detected in the corresponding point detecting step between the reference right image and the adjacent right image adjacent to it are matched, wherein a stereoscopic image including the left image and the right image subjected to geometric deformation is set as a next reference stereoscopic image when there are the left image and the right image subjected to projective transform that are adjacent to the left image and the right image subjected to geometric deformation, and the left image and the right image subjected to projective transform are subjected to geometric deformation as above; and a step of synthesizing a left panorama image based on the left image of the first reference stereoscopic image and the left image subjected to geometric deformation and synthesizing a right panorama image based on the right image of the first reference stereoscopic image and the right image subjected to geometric deformation.

According to the presently disclosed subject matter, it is possible to synthesize a stereoscopic panorama image from a plurality of images taken by panning a multi-eye imaging device and, specifically, perform good panorama image synthesis such that the stereoscopic effect of subjects in the same distance in right and left panorama images does not change by the imaging direction.

### BRIEF DESCRIPTION OF THE DRAWINGS

FIG. 1A is a front perspective view of a stereoscopic imaging device according to the presently disclosed subject matter;

FIG. 1B is a back perspective view of the stereoscopic imaging device according to the presently disclosed subject matter;

FIG. 2 is a block diagram illustrating an internal configuration of a multi-eye imaging device in FIGS. 1A-1B;

FIG. 3A is a view illustrating an imaging method of 3D images for 3D panorama synthesis;

FIG. 3B is a view illustrating an imaging method of 3D images for 3D panorama synthesis;

FIG. 4 is a view for explaining viewing angle adjustment at the time of imaging of 3D images for 3D panorama synthesis;

FIG. 5 is a flowchart illustrating a first embodiment of 3D panorama image synthesis;

FIG. 6A is a view illustrating an outline of synthesis processing in each processing step in FIG. 5;

FIG. 6B is a view illustrating an outline of synthesis processing in each processing step in FIG. 5;

FIG. 6C is a view illustrating an outline of synthesis processing in each processing step in FIG. 5;

FIG. 6D is a view illustrating an outline of synthesis processing in each processing step in FIG. 5;

FIG. 6E is a view illustrating an outline of synthesis processing in each processing step in FIG. 5;

FIG. 6F is a view illustrating an outline of synthesis processing in each processing step in FIG. 5;

FIG. 6G is a view illustrating an outline of synthesis processing in each processing step in FIG. 5;

FIG. 6H is a view illustrating an outline of synthesis processing in each processing step in FIG. 5;

FIG. 6I is a view illustrating an outline of synthesis processing in each processing step in FIG. 5;

FIG. 7 is a flowchart illustrating a second embodiment of 3D panorama image synthesis;

FIG. 8A is a view illustrating an outline of synthesis processing in each processing step in FIG. 7;

FIG. 8B is a view illustrating an outline of synthesis processing in each processing step in FIG. 7;

FIG. 8C is a view illustrating an outline of synthesis processing in each processing step in FIG. 7;

FIG. 8D is a view illustrating an outline of synthesis processing in each processing step in FIG. 7;

FIG. 8E is a view illustrating an outline of synthesis processing in each processing step in FIG. 7;

FIG. 8F is a view illustrating an outline of synthesis processing in each processing step in FIG. 7;

FIG. 8G is a view illustrating an outline of synthesis processing in each processing step in FIG. 7;

FIG. 8H is a view illustrating an outline of synthesis processing in each processing step in FIG. 7;

FIG. 8I is a view illustrating an outline of synthesis processing in each processing step in FIG. 7;

FIG. 8J is a view illustrating an outline of synthesis processing in each processing step in FIG. 7; and

FIG. 9 is a histogram illustrating an example of frequency distribution of disparity amounts.

### DETAILED DESCRIPTION OF THE EMBODIMENTS

In the following, with reference to the accompanying drawings, an explanation is given to embodiments of a stereoscopic panorama image synthesizing device, multi-eye imaging device and stereoscopic panorama image synthesizing method according to the presently disclosed subject matter.

### [Outline View of Multi-Eye Imaging Device]

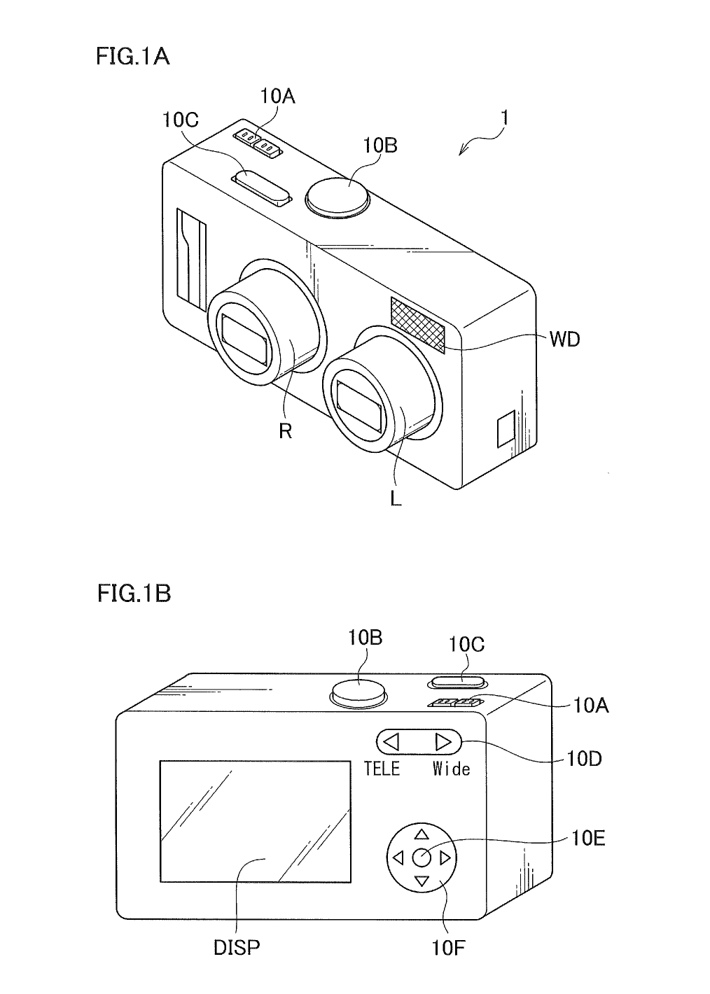

FIGS. 1A-1B is an outline view of a multi-eye imaging device according to the presently disclosed subject matter, FIG. 1A is a perspective view seen from the diagonally top of the front of a multi-eye imaging device 1 and FIG. 1B is a perspective view seen from the back of the multi-eye imaging device 1.

As illustrated in FIG. 1A, the multi-eye imaging device 1 has left and right imaging units L and R. In the following, these imaging units are described as a first imaging unit L and a second imaging unit R for classification.

The first imaging unit L and the second imaging unit R are adjacently arranged such that it is possible to acquire image signals for stereoscopic view. By these imaging units L and R, left and right image signals are generated. A power supply switch 10A on the upper surface of the multi-eye imaging device 1 in FIGS. 1A and 1B is operated, and when an imaging mode dial 10B is set to, for example, a mode called stereoscopic mode and a shutter button 10C is operated, image data for stereoscopic view is generated in both the imaging units L and R.

The shutter button 10C provided in the multi-eye imaging device 1 according to this embodiment has two operation aspects of half press and full press. In the multi-eye imaging device 1, exposure adjustment and focus adjustment are implemented when the shutter button 10C is pressed halfway, and imaging is implemented when it is pressed fully. Also, a flash light emission window WD, which emits flash light to a subject when the field brightness is dark, is provided above the imaging unit L.

Also, as illustrated in FIG. 1B, a liquid crystal monitor DISP that enables three-dimensional display is provided in the back of the multi-eye imaging device 1, and this liquid crystal monitor DISP displays a stereoscopic image of an identical subject captured by both the imaging units L and R. Also, as the liquid crystal monitor DISP, it is possible to apply a liquid crystal monitor using a lenticular lens or parallax barrier, and a liquid crystal monitor that enables the right image and the left image to be looked individually by wearing dedicated glasses such as polarized glasses and liquid crystal shutter glasses. Further, operation parts such as a zoom switch 10D, menu/OK button 10E and arrow key 10F are arranged. In the following, the power supply switch 10A, the mode dial 10B, the shutter button 10C, the zoom switch 10D, the menu/OK button 10E and the arrow key 10F may be collectively referred to as an operation unit 10.

### [Internal Configuration of Multi-Eye Imaging Device 1]

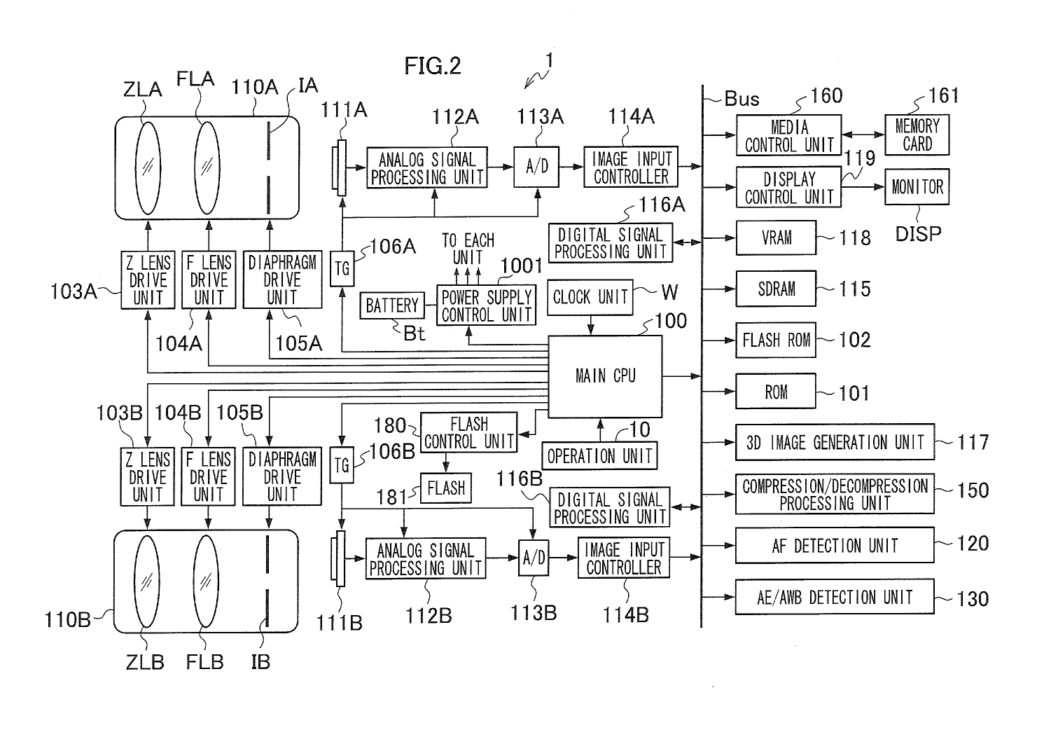

FIG. 2 is a block diagram illustrating an internal configuration of the multi-eye imaging device 1 in FIGS. 1A-1B. With reference to FIG. 2, the internal configuration of the multi-eye imaging device 1 is explained.

Operations of this multi-eye imaging device 1 are integrally controlled by a main CPU (Central Processing Unit) 100.

A ROM (Read-Only Memory) 101 is connected to the main CPU 100 via a bus Bus and stores programs required to operate this multi-eye imaging device 1. According to procedure of this program, the main CPU 100 integrally controls the operations of this multi-eye imaging device 1 based on an instruction from the operation unit 10.

The mode dial 10B of the operation unit 10 is an operation member for a selection operation to select an automatic imaging mode, a manual imaging mode, a scene position such as a person, landscape and night scene, a motion picture mode to capture a motion picture, or a stereoscopic (3D) panorama imaging mode according to the presently disclosed subject matter. Also, a playback button (not illustrated) of the operation unit 10 is a button to switch a mode to a playback mode to display an imaged and recorded still picture or motion picture on the liquid crystal monitor DISP. The menu/OK button 10E is an operation key having a function as a menu button to give an instruction to display a menu on a screen of the liquid crystal monitor DISP and a function as an OK button to give an instruction to determine and execute selection content. The arrow key 10F is an operation unit to input an instruction of four directions of left, right, top and bottom, and functions as a button (operation member for a cursor movement operation) to select an item from the menu screen or instruct selection of various setting items from each menu. Also, the top and bottom keys of the arrow key 10F function as a zoom switch at the time of imaging or a playback zoom switch at the time of playback mode, and the left and right keys function as a frame advance (forward direction/backward direction advance) button at the time of playback mode.

First, when the power supply switch 10A in the operation unit 10 illustrated in FIG. 1 is operated, the main CPU 100 controls a power supply control unit 1001 to supply power from a battery Bt to each unit of the multi-eye imaging device 1 via the power supply control unit 1001 and shift this multi-eye imaging device 1 to an operation state. Thus, the main CPU 100 starts imaging processing. Also, an AF detection unit 120, an AE/AWB detection unit 130, an image input controller 114A, a digital signal processing unit 116A and a 3D image generation unit 117 can be configured by a processor such as a DSP (Digital Signal Processor), and it is assumed that the main CPU 100 performs processing in cooperation with the DSP.

Here, an internal configuration of the first imaging unit L and the second imaging unit R explained above in FIG. 1 is explained with reference to FIG. 2. Also, an explanation is given where the term “first” is attached to each configuration member of the first imaging unit L and the term “second” is attached to each configuration member of the second imaging unit R.

The first imaging unit L is provided with: a first imaging optical system 110A including a first focus lens FLA; a first focus lens drive unit (hereinafter referred to as first F lens drive unit) 104A that moves the first focus lens FLA in the light axis direction; and a first imaging element 111A that receives subject light acquired by forming the subject in the first imaging optical system and generates an image signal representing the subject. Further, this first imaging optical system 110A is provided with a first diaphragm IA and a first diaphragm drive unit 105A that changes the opening size of this first diaphragm IA.

Also, the first imaging optical system 110A is a zoom lens and is provided with a Z lens drive unit 103A that controls the zoom lens to a predetermined focusing distance. Also, using one lens ZL, FIG. 2 schematically illustrates that the whole imaging optical system is the zoom lens.

Meanwhile, similar to the above first imaging unit L, the second imaging unit R is provided with: an imaging optical system including a second focus lens FLB; a second focus lens drive unit (hereinafter referred to as second F lens drive unit) 104B that moves the second focus lens FLB in the light axis direction; and a second imaging element 111B that receives subject light acquired by forming the subject in the second imaging optical system and generates an image signal representing the subject.

In these first imaging unit L and second imaging unit R, image signals for stereoscopic view, that is, a left image signal is generated in the first imaging unit L and a right image signal is generated in the second imaging unit R.

The first imaging unit L and the second imaging unit R have the same configuration, except that the first imaging unit L generates the left image signal and the second imaging unit R generates the right image signal, and also have the common signal processing after the image signals of both the imaging units are converted into digital signals in a first A/D conversion unit 113A and second A/D conversion unit 113B and sent to the bus Bus. Therefore, the configuration is explained below along a flow of image signals in the first imaging unit L.

First, an explanation is given to an operation of displaying a subject captured by the first imaging unit L as is on the liquid crystal monitor DISP as a through image.

When the power supply switch 10A in the operation unit 10 is operated, the main CPU 100 controls the power supply control unit 1001 to supply power from the battery Bt to each unit and shift this multi-eye imaging device 1 to an operation state.

First, the main CPU 100 controls the F lens drive unit 104A and the diaphragm drive unit 105A to start exposure and focus adjustment. Further, a timing generator (TG) 106A is instructed to cause the imaging element 111A to set an exposure time by an electronic shutter such that an image signal is output from the imaging element 111A to an analog signal processing unit 112A every 1/60 second, for example.

The analog signal processing unit 112A receives a supply of a timing signal from the TG 106A, receives a supply of an image signal from the imaging element 111A every 1/60 second and performs noise reduction processing or the like. The analog image signal subjected to noise reduction processing is supplied to the A/D conversion unit 113A on the next stage. In synchronization with the timing signal from the TG 106A, this A/D conversion unit 113A performs processing of converting the analog image signal into a digital signal every 1/60 second. The digital image signal converted and output in the A/D conversion unit 113A in this way is sent to the bus Bus by the image input controller 114A every 1/60 second. This image signal sent to the bus Bus is stored in an SDRAM (Synchronous Dynamic Random Access Memory) 115. Since an image signal is output from the imaging element 111A every 1/60 second, content of this SDRAM 115 is overwritten every 1/60 second.

This image signal stored in the SDRAM 115 is read by the AF detection unit 120, the AE/AWB detection unit 130 and the DSP forming the digital signal processing unit 116A every 1/60 second.

In the AF detection unit 120, every 1/60 second while the main CPU 100 controls the F lens drive unit 104A to move the focus lens FLA, high-frequency components of image signals in a focus area are extracted and integrated to calculate an AF evaluation value indicating the image contrast. The main CPU 100 acquires the AF evaluation value calculated by the AF detection unit 120 and moves the first focus lens FLA to a lens position (focusing position) in which the AF evaluation value is maximum, via the F lens drive unit 104A. Therefore, regardless of which direction the first imaging unit L faces, the focus is soon adjusted and the liquid crystal monitor DISP almost always displays an in-focus subject.

Also, every 1/60 second, the AE/AWB detection unit 130 detects the subject brightness and calculates the gain set to a white balance amplifier in the digital signal processing unit 116A. The main CPU 100 controls the diaphragm drive unit 105A based on this brightness detection result in the AE/AWB detection unit 130 and changes the opening size of the diaphragm IA. Also, the digital signal processing unit 116A sets the gain of the white balance amplifier according to the detection result from the AE/AWB detection unit 130.

In this digital signal processing unit 116A, processing to make an image signal suitable for display is performed, the image signal converted to be suitable for display by the signal processing in the digital signal processing unit 116A is supplied to the 3D image generation unit 117, a right image signal for display is generated in the 3D image generation unit 117 and the generated right image signal is stored in a VRAM (Video Random Access Memory) 118.

The same operations as the above are also performed by the second imaging unit R at the same timing. Therefore, the VRAM 118 stores two kinds of right and left image signals.

The main CPU 100 transfers the right image signal and the left image signal in the VRAM 118 to a display control unit 119 to display these images on the liquid crystal monitor DISP. When the right image signal and the left image signal are displayed on the liquid crystal monitor DISP in FIG. 1, the images on the liquid crystal monitor DISP appear to human eyes as stereoscopic images. The first and second imaging elements 111A and 111B continuously output image signals every 1/60 second, and, consequently, the image signals in the VRAM 118 are overwritten every 1/60 second, the stereoscopic images on the liquid crystal monitor DISP are switched every 1/60 second and the stereoscopic images are displayed as motion pictures.

Here, when the shutter button 10C in the operation unit 10 is pressed halfway with reference to the subject on the liquid crystal monitor DISP, the main CPU 100 receives an AE value detected in the AE/AWB detection unit 130 immediately before the shutter button 10C is pressed fully, so as to: adjust the first and second diaphragms IA and IB to a diaphragm size based on the AE value by the first and second diaphragm drive units 105A and 105B; move the first focus lens FLA and the second focus lens FLB in a predetermined search range by the first F lens drive unit 104A and the second F lens drive unit 104B; and calculate an AF evaluation value by the AF detection unit 120.

Based on the AF evaluation value calculated by the AF detection unit 120, the main CPU 100 detects lens positions of the first focus lens FLA and the second focus lens FLB in which the AF evaluation value is maximum, and moves the first focus lens FLA and the second focus lens FLB to the first lens position and the second lens position, respectively.

Subsequently, when the shutter button 10C is pressed fully, the main CPU 100 causes the first imaging element 111A and the second imaging element 111B to be exposed based on a predetermined shutter speed by the first and second TGs 106A and 106B so as to image still pictures. The main CPU 100 causes image signals to be output from the first and second imaging elements 111A and 111B to the first and second analog signal processing units 112A and 112B at the timing when the electronic shutter is turned off, and causes the first and second analog signal processing units 112A and 112B to perform noise reduction processing. After that, the first and second A/D conversion units 113A and 113B are caused to convert the analog image signals into digital image signals.

Here, according to an instruction of the main CPU 100, the first and second image input controllers 114A, 114B temporarily store the digital image signals converted by the first and second A/D conversion units 113A and 113B, in the SDRAM 115 via the bus Bus. After that, the digital signal processing units 116A and 116B read the image signals in the SDRAM 115, perform image processing including white balance correction, gamma correction, synchronization processing (color interpolation processing) of correcting a spatial gap of color signals such as R (Red), G (Green) and B (Blue) based on a color filter array of a single-plate CCD (Charge-Coupled Device) to match the positions of each color signal, contour correction and generation of brightness/color-difference signals (YC signals), and feed the image signals to the 3D image generation unit 117.

Subsequently, the main CPU 100 supplies the right image signal and the left image signal in the 3D image generation unit 117 to a compression/decompression processing unit 150 using the bus Bus. After image data compression in this compression/decompression processing unit 150, the main CPU 100 transfers the compressed image data to a media control unit using the bus Bus while supplying header information related to the compression or imaging to the media control unit 160, causes the media control unit 160 to generate a predetermined-format image file (for example, in the case of 3D still pictures, MP (Multi-Picture)-format image file), and records the image file in the memory card 161.

When a 3D panorama imaging mode is selected by the mode dial 10B of the operation unit 10, the main CPU 100 performs processing for imaging a plurality of stereoscopic images required for 3D panorama image synthesis. Also, the 3D image generation unit 117 functions as an image processing unit to generate a 3D panorama image from a plurality of 3D images (a plurality of left images and right images) taken at the time of the 3D panorama imaging mode.

Also, details of operations of the multi-eye imaging device 1 at the time of the 3D panorama imaging mode is described later. Also, FIG. 2 illustrates a flash control unit 180, a flash 181 that emits flash light from the light emission window WD in FIG. 1 in response to an instruction from the flash control unit 180, and a clock unit W that senses the current time.

### <Acquisition of 3D Images for 3D Panorama Synthesis>

In the case of taking 3D images for 3D panorama synthesis, the 3D panorama imaging mode is selected by the mode dial 10B of the operation unit 10.

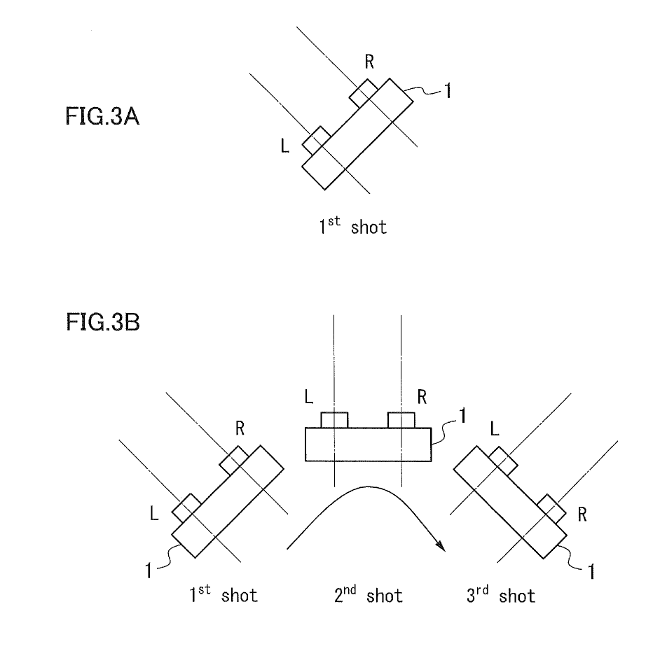

After that, a first 3D image is taken by the multi-eye imaging device 1 as illustrated in FIG. 3 (FIG. 3A). In a case where the 3D panorama imaging mode is set, the main CPU 100 performs control such that the focus position, exposure condition and white balance gain used for the first 3D image are fixed until the predetermined number of subsequent 3D images are completely taken.

When finishing taking the first 3D image, the photographer changes the imaging direction by panning the multi-eye imaging device 1 and takes a second 3D image (FIG. 3B).

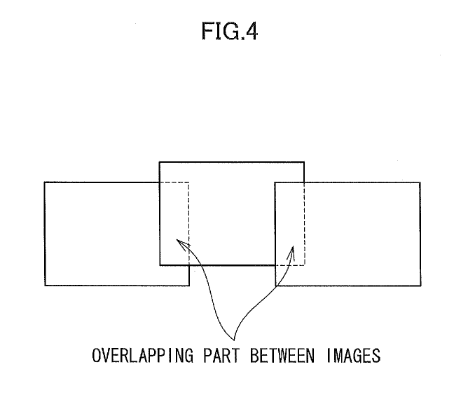

At this time, the photographer adjusts the imaging direction of the multi-eye imaging device 1 such that the first 3D image and the second 3D image are partially overlapped with each other as illustrated in FIG. 4, and takes an image. At the time of the 3D panorama imaging mode, it is preferable that the main CPU 100 cause the liquid crystal monitor DISP to display part of the 3D images taken in advance so as to assist the imaging direction at the time of next imaging. That is, the photographer can determine the imaging direction while checking part of the 3D images, which have been taken in advance and are displayed on the liquid crystal monitor DISP, and a through image.

As described above, when the preset number or the default number of 3D images have been completely taken, the main CPU 100 decides that the 3D images for 3D panorama synthesis have been completely taken, and the flow proceeds to subsequent 3D panorama image synthesis processing.

### First Embodiment

Next, the first embodiment of 3D panorama image synthesis is explained.

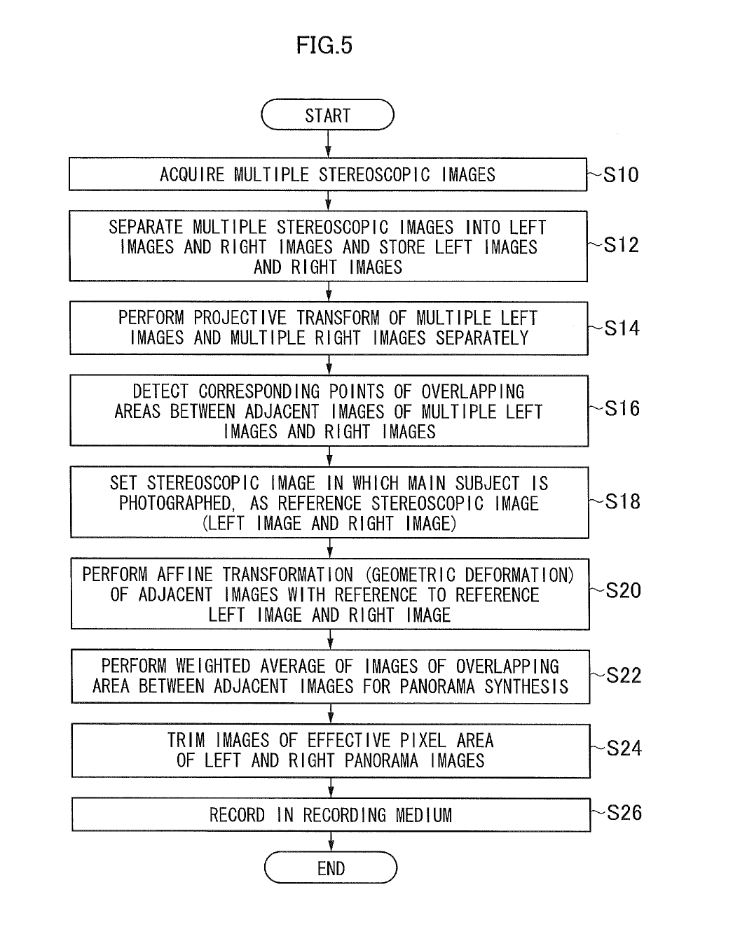

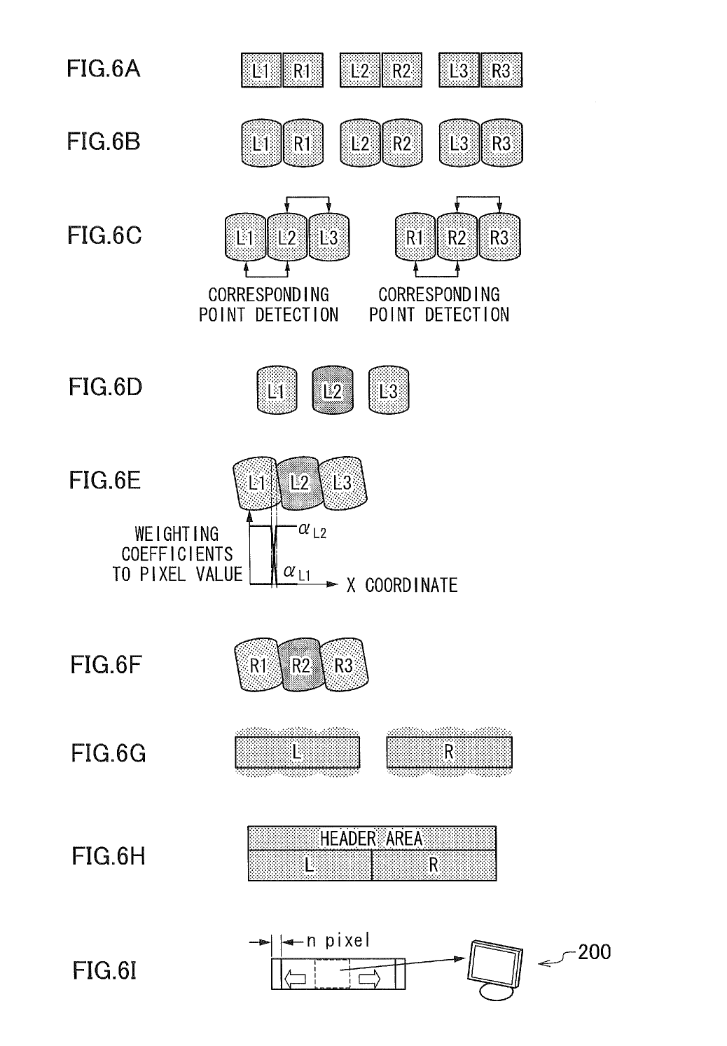

FIG. 5 is a flowchart illustrating the first embodiment of the 3D panorama image synthesis and FIGS. 6A to 6I are views illustrating an outline of the synthesis processing in each processing step.

In FIG. 5, when a plurality of stereoscopic images (3D images) are acquired by imaging in the 3D panorama imaging mode as described above (step S10), these multiple 3D images are classified into the left images and the right images and primarily saved in the SDRAM 115 (step S12). Also, FIG. 6 illustrates a case where the total number of taken 3D images is three, and three left images L1, L2 and L3 and three right images R1, R2 and R3 are temporarily saved in the SDRAM 115 (FIG. 6A).

Regarding the three left images L1, L2 and L3 and the three right images R1, R2 and R3 primarily saved in the SDRAM 115, the 3D image generation unit 117 performs projective transform of these onto an identical projection surface (e.g. cylinder surface) and saves the three left images L1, L2 and L3 and three right images R1, R2 and R3 subjected to projective transform, in the SDRAM 115 again (step S14, FIG. 6B). By this projective transform, it is possible to perform panorama synthesis of the three left images L1, L2 and L3 and the three right images R1, R2 and R3.

Next, corresponding points are detected in the overlapping area between adjacent images among the three left images L1, L2 and L3 subjected to projective conversion, and, similarly, corresponding points are detected in the overlapping area between adjacent images among the three right images R1, R2 and R3 (step S16, FIG. 6C). Here, examples of a corresponding point detecting method include a method of extracting feature points using a Harris method or the like and tracing the feature points using a KLT (Kanade Lucas Tomasi) method or the like.

In a case where it is not possible to detect a corresponding point or where the number of detected corresponding points is equal to or less than the number required to specify a geometric deformation parameter which is described later, it is decided that the synthesis is impossible, and the synthesis processing is stopped.

Subsequently, a 3D image photographing a main subject is detected from the three 3D images and this 3D image photographing the main subject is set as a reference 3D image (left image and right image) (step S18, FIG. 6D). That is, the main subject (e.g. face) is detected, and a 3D image in which the number of faces is the largest or a 3D image in which the face size is the largest is set as a reference 3D image.

Here, in a case where it is not possible to detect the main subject, the image closest to the center of the multiple 3D images is set as a reference 3D image. For example, in a case where the total number of taken 3D images is n, an n/2-th (n: even number) or (n+1)/2-th (n: odd number) 3D image is set as a reference 3D image. In the examples illustrated in FIGS. 6A to 6I, since the total number of taken 3D images is three, in a case where it is not possible to detect the main subject from each 3D image, the second 3D image in the imaging order (the left image L2 and the right image R2) is set as a reference 3D image (FIG. 6D).

Next, with reference to the reference left image and the reference right image (the left image L2 and the right image R2 in the examples of FIGS. 6A to 6I) set in step S18, adjacent left images L1 and L3 and adjacent right images R1 and R3 are subjected to affine transformation based on the corresponding points detected in step S16 (step S20).

That is, based on the corresponding points detected from the overlapping area between the reference left image L2 and the left image L1, the left image L1 is subjected to affine transformation such that the corresponding points of the left image L1 match the corresponding points of the left image L2, and, based on the corresponding points detected from the overlapping area between the reference left image L2 and the left image L3, the left image L3 is subjected to affine transformation such that the corresponding points of the left image L3 match the corresponding points of the left image L2 (FIG. 6E).

Similarly, based on the corresponding points detected from the overlapping area between the reference right image R2 and the right image R1, the right image R1 is subjected to affine transformation such that the corresponding points of the right image R1 match the corresponding points of the right image R2, and, based on the corresponding points detected from the overlapping area between the reference right image R2 and the right image R3, the right image R3 is subjected to affine transformation such that the corresponding points of the right image R3 match the corresponding points of the right image R2 (FIG. 6F). By the above affine transformation, the parallel shift, rotation and scaling of images are performed.

Also, in the examples illustrated in FIGS. 6A to 6I, the total number of taken images is three. However, for example, in a case where the total number of taken images is four and a fourth left image L4 is subjected to affine transformation, with reference to the left image L3 subjected to affine transformation, based on corresponding points detected from the overlapping area between this left image L3 and the left image L4, the left image L4 is subjected to affine transformation such that the corresponding points of the left image L4 match the corresponding points of the left image L3 subjected to affine transformation.

Also, when the right images R1 and R3 are subjected to affine transformation, it is preferable to perform the affine transformation by taking into account the disparity amount with respect to the left images L1 and L3 already subjected to affine transformation. That is, feature points are found in which the disparity amount is 0 between the left images L1 and L3 and in which the disparity amount is 0 between the right images R1 and R3, in the original 3D images for 3D panorama synthesis. Subsequently, the right images R1 and R3 are subjected to affine transformation such that the feature points of the left images L1 and L3 subjected to affine transformation (feature points in which the disparity amount is 0) match the corresponding feature points of the right images R1 and R3 (feature points in which the disparity amount is 0).

As described above, although a left panorama image is synthesized from the reference left image L2 and the left images L1 and L3 subjected to affine transformation, before this synthesis, images of the overlapping area between adjacent images are subjected to weighted average and synthesized (step S22). That is, as illustrated in FIG. 6E, when the left image L1 and the left image L2 are synthesized, a weighting coefficient for the pixel value of the left image L1 is set to α_{L1} and a weighting coefficient for the pixel value of the left image L2 is set to α_{L2}, and the images of the overlapping area between these images are subjected to weighted average using the weighting coefficients α_{L1} and α_{L2}. Also, similarly, in the case of synthesizing a right panorama image from the reference right image R2 and the right images R1 and R2 subjected to affine transformation, images of the overlapping area between adjacent images are subjected to weighted average and synthesized

Next, a trimming area is determined which satisfies the AND condition of an area including effective pixels of the left panorama image and right panorama image synthesized as above, and images of the determined trimming area are cut out (trimmed) (step S24, FIG. 6G). Also, in a case where the size of the determined trimming area is equal to or smaller than a certain size, it is decided that the imaging fails, and the synthesis processing is stopped.

The left panorama image and right panorama image trimmed as above are associated with each other as 3D panorama images and recorded in a recording medium (memory card 161) (step S26).

For example, as illustrated in FIG. 6H, the left panorama image and the right panorama image are stored in an image file as a side-by-side format (format in which the left panorama image and the right panorama image are adjacently arranged and stored), and, in the header area of the image file, a representative disparity amount of the reference 3D image set in step S18 (for example, the disparity amount of the main subject) is written. The image file created as above is recorded in the memory card 161.

The 3D panorama images created as above can be displayed on an external 3D display 200 as illustrated in FIG. 6I.

Also, this multi-eye imaging device 1 includes an output device (such as a communication interface) to display 3D images or the above 3D panorama images on the external 3D display. At the time of displaying the 3D panorama image, in a case where the header area of the image file records n pixels as a representative disparity amount, by shifting the head address of the R panorama image by n pixels with respect to the left panorama image, it is possible to display the 3D panorama image subjected to disparity adjustment by which the representative disparity amount (the disparity amount of the main subject) becomes 0. Also, in the case of performing a scroll playback, it is partially cut out and enlarged. By moving the cut position, it is possible to scroll the 3D panorama image.

### Second Embodiment

Next, a second embodiment of the 3D panorama image synthesis is explained.

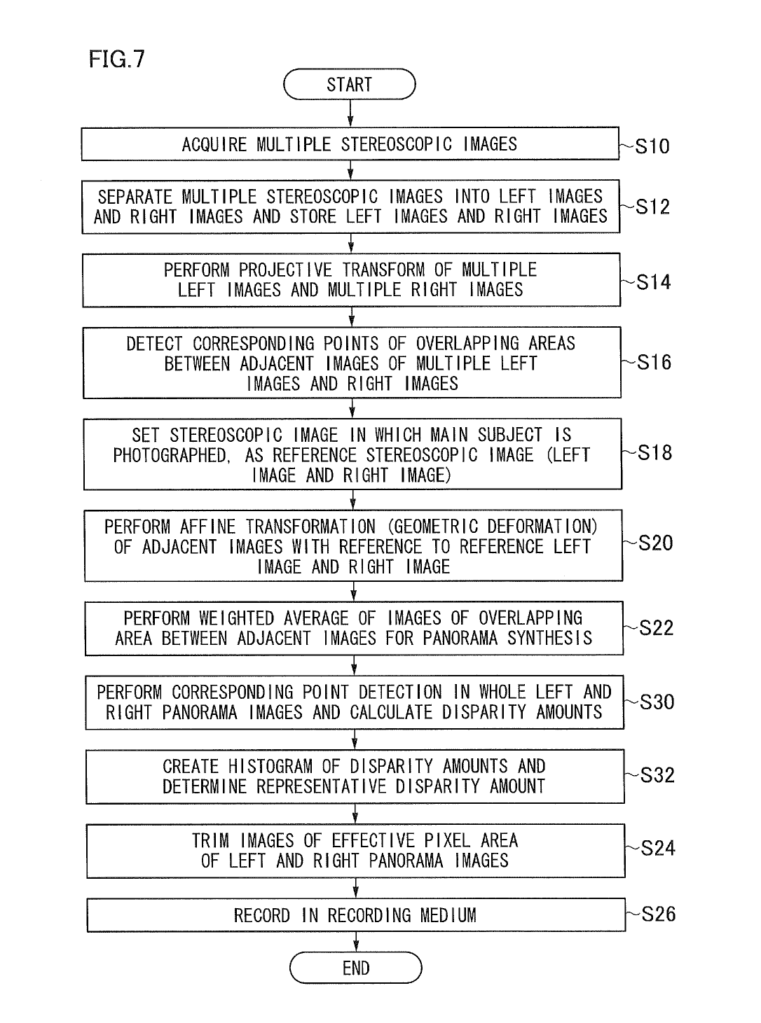

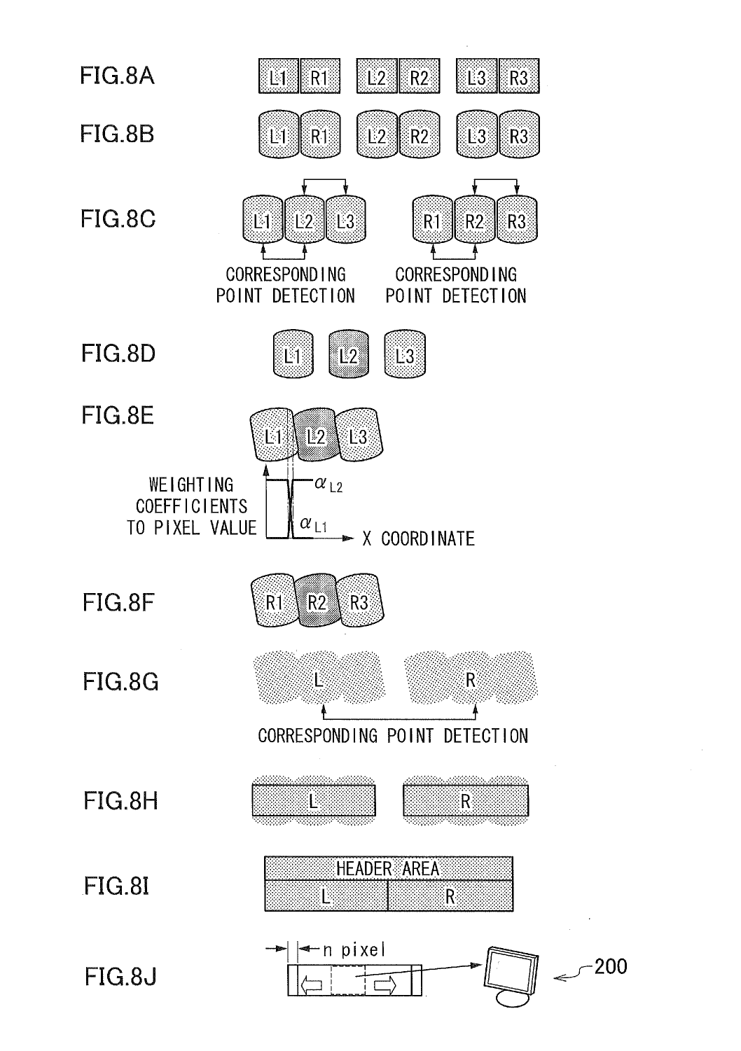

FIG. 7 is a flowchart illustrating the second embodiment of the 3D panorama image synthesis, and FIGS. 8 A to 8J are views illustrating an outline of the synthesis processing in each processing step. Here, the same step numbers are assigned to the common parts with the first embodiment 1 illustrated in FIG. 5 and their specific explanation is omitted. Also, FIGS. 8A to 8J are similar to FIGS. 6A to 6I, except that FIG. 8G is added compared to FIGS. 6A to 6I.

The second embodiment illustrated in FIG. 7 differs from the first embodiment in the way of adding processing in steps S30 and S32.

In step S30, a corresponding point per pixel is detected in the whole image of the left panorama image and right panorama image subjected to panorama synthesis, and the disparity amounts between the detected corresponding points are calculated (FIG. 8G).

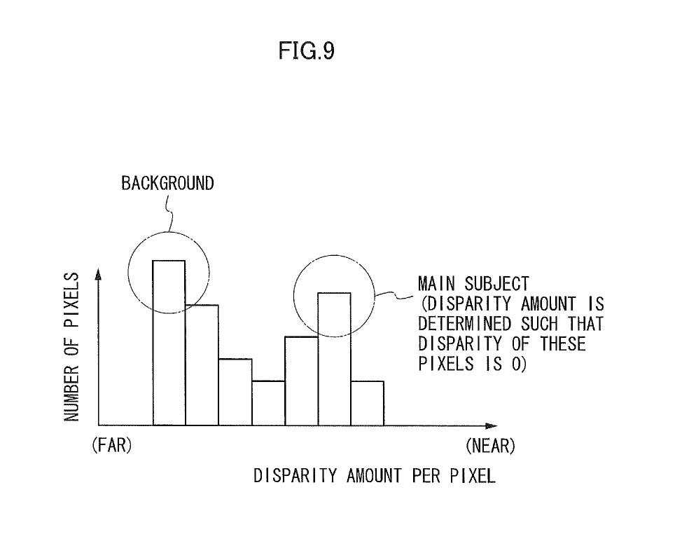

Subsequently, the histogram of the disparity amounts calculated on a pixel-by-pixel basis is created and a representative disparity amount is determined based on this created histogram (step S32). FIG. 9 illustrates an example of the histogram of pixel-based disparity amounts.

In the histogram illustrated in FIG. 9, there are two frequency peaks. The disparity amount peak on the farthest side is considered as the disparity amount of the background and the peak on the nearest side is considered as the disparity amount of the main subject. Therefore, as a method of determining a representative disparity amount based on the histogram, the disparity amount of the peak on the nearest side can be used as a representative disparity amount. Also, a method of determining a representative disparity amount based on a histogram is not limited to the above method, and, for example, the average value or median value may be used.

Subsequent processing is performed in the same way as in the first embodiment. Here, in step S26, in the header area of the image file recorded in the recording medium (the memory card 161), the representative disparity amount determined in step S32 is written.

### [Others]

The multi-eye imaging device according to the presently disclosed subject matter incorporates a 3D panorama image synthesizing function to take and acquire a plurality of 3D images for 3D panorama synthesis and synthesize a 3D panorama image from the multiple acquired 3D images. The 3D panorama image synthesizing device according to the presently disclosed subject matter may be configured with an external device such as a personal computer without an imaging function. In this case, a plurality of 3D images for 3D panorama synthesis taken by a general multi-eye imaging device are input in the 3D panorama image synthesizing device and a 3D panorama image is synthesized.

Also, in the present embodiment, although the representative disparity amount of a 3D panorama image is recorded in the header area of the image file, the presently disclosed subject matter is not limited to this. At the time of determining and trimming a trimming area from the left panorama image and right panorama image subjected to panorama synthesis, it may be possible to determine and trim the trimming area such that the representative disparity amount is a predetermined disparity amount (for example, the disparity amount is 0)

Also, the presently disclosed subject matter can be provided as a computer-readable program that causes a personal computer or the like to perform the above 3D panorama image synthesis processing, and a recording medium storing the program.

Further, the presently disclosed subject matter is not limited to the above embodiments and it is needless to say that various changes can be made within the scope without departing from the spirit of the presently disclosed subject matter.

What is claimed is:

1. A stereoscopic panorama image synthesizing device comprising:
an image acquisition unit configured to acquire a plurality of stereoscopic images including left images and right images taken by a multi-eye imaging device, the left images and right images being taken in each imaging direction by panning the multi-eye imaging device;
a storage unit configured to separate the left images and the right images from the plurality of acquired stereoscopic images and to store the left images and the right images separately;
a projective transformation unit configured to perform projective transform of the plurality of stored left images and right images onto an identical projection surface separately;
a corresponding point detection unit configured to detect a corresponding point in an overlapping area between the plurality of left images subjected to projective transform and to detect a corresponding point in an overlapping area between the plurality of right images subjected to projective transform;
a main subject detection unit configured to detect a main subject from the plurality of stereoscopic images acquired by the image acquisition unit;
a reference image setting unit configured to set a first reference stereoscopic image among the plurality of stereoscopic images and to set a stereoscopic image in which the main subject has been detected by the main subject detection unit as the first reference stereoscopic image;
an image deformation unit configured, with reference to the left image and the right image subjected to projective transform in the set first reference stereoscopic image, to perform geometric deformation of an adjacent left image such that the corresponding points detected by the corresponding point detection unit between the reference left image and the adjacent left image adjacent to it are matched, and to perform geometric deformation of an adjacent right image such that the corresponding points detected by the corresponding point detection unit between the reference right image and the adjacent right image adjacent to it are matched, wherein a stereoscopic image including the left image and the right image subjected to geometric deformation is set as a next reference stereoscopic image when there are the left image and the right image subjected to projective transform that are adjacent to the left image and the right image subjected to geometric deformation, and the left image and the right image subjected to projective transform are subjected to geometric deformation as above;
a panorama synthesis unit configured to synthesize a left panorama image based on the left image of the first reference stereoscopic image and the left image subjected to geometric deformation and to synthesize a right panorama image based on the right image of the first reference stereoscopic image and the right image subjected to geometric deformation;
a representative disparity amount acquisition unit configured to acquire a representative disparity amount of the left panorama image and the right panorama image; and
a trimming unit configured to trim images of an area having a mutually overlapping effective pixel, from each of the left panorama image and the right panorama image synthesized by the panorama synthesis unit,
wherein the trimming unit determines and trims trimming areas of the synthesized left panorama image and the synthesized right panorama image such that the representative disparity amount acquired by the representative disparity amount acquisition unit is a preset disparity amount.

2. The stereoscopic panorama image synthesizing device according to claim 1,
wherein, in a case where the main subject has not been detected by the main subject detection unit, the reference image setting unit sets a stereoscopic image closest to a center in an imaging order among the plurality of stereoscopic images, as the first reference stereoscopic image.

3. The stereoscopic panorama image synthesizing device according to claim 1,
wherein, at a time of synthesizing the left panorama image and the right panorama image, images of an overlapping area between adjacent images are subjected to weighted average and synthesized by the panorama synthesis unit.

4. The stereoscopic panorama image synthesizing device according to claim 1, further comprising
a recording unit configured to record, in a recording medium, the left panorama image and the right panorama image generated by the panorama synthesis unit in association with each other.

5. The stereoscopic panorama image synthesizing device according to claim 4,
wherein the recording unit records, in the recording medium, the representative disparity amounts acquired by the representative disparity amount acquisition unit in association with the left panorama image and the right panorama image.

6. The stereoscopic panorama image synthesizing device according to claim 5, further comprising
an output unit configured to output the left panorama image and the right panorama image recorded in association in the recording medium,
wherein the output unit relatively shifts pixels of the left panorama image and the right panorama image such that, based on the representative disparity amounts recorded in association with the left panorama image and the right panorama image, the representative disparity amounts match a preset disparity amount, and outputs the left panorama image and the right panorama image.

7. The stereoscopic panorama image synthesizing device according to claim 1,
wherein the representative disparity amount acquisition unit acquires the representative disparity amount based on the reference stereoscopic image set by the reference image setting unit.

8. The stereoscopic panorama image synthesizing device according to claim 1,
wherein the representative disparity amount acquisition unit comprises:
a corresponding point detection unit configured to detect a corresponding point per pixel of the left panorama image and the right panorama image;
a disparity amount calculation unit configured to calculate a disparity amount between the detected corresponding points;
a histogram creation unit configured to create a histogram of the disparity amounts calculated on a pixel-by-pixel basis; and
a representative disparity amount determination unit configured to determine a representative disparity amount based on the created histogram.

9. A multi-eye imaging device comprising:
a plurality of imaging units used as the image acquisition unit; and
the stereoscopic panorama image synthesizing device according to claim 1.

10. The multi-eye imaging device according to claim 9, further comprising:
a mode setting unit configured to set a stereoscopic panorama imaging mode; and
a control unit configured to fix, when the stereoscopic panorama imaging mode is selected, a focus position, an exposure condition and a white balance gain of a stereoscopic image taken in every imaging direction, to a value set at a time of taking a first image.

11. A stereoscopic panorama image synthesizing method comprising:
a step of acquiring a plurality of stereoscopic images including left images and right images taken by a multi-eye imaging device, the left images and right images being taken in each imaging direction by panning the multi-eye imaging device;
a step of separating the left images and the right images from the plurality of acquired stereoscopic images and storing the left images and the right images separately;
a step of performing projective transform of the plurality of stored left images and right images onto an identical projection surface separately;
a corresponding point detecting step of detecting a corresponding point in an overlapping area between the plurality of left images subjected to projective transform and detecting a corresponding point in an overlapping area between the plurality of right images subjected to projective transform;
a step of detecting a main subject from the acquired plurality of stereoscopic images;
a step of setting a first reference stereoscopic image among the plurality of stereoscopic images and setting a stereoscopic image, in which the main subject has been detected, as the first reference stereoscopic image;
a step of, with reference to the left image and the right image subjected to projective transform in the set first reference stereoscopic image, performing geometric deformation of an adjacent left image such that the corresponding points detected in the corresponding point detecting step between the reference left image and the adjacent left image adjacent to it are matched, and performing geometric deformation of an adjacent right image such that the corresponding points detected in the corresponding point detecting step between the reference right image and the adjacent right image adjacent to it are matched, wherein a stereoscopic image including the left image and the right image subjected to geometric deformation is set as a next reference stereoscopic image when there are the left image and the right image subjected to projective transform that are adjacent to the left image and the right image subjected to geometric deformation, and the left image and the right image subjected to projective transform are subjected to geometric deformation as above;
a step of synthesizing a left panorama image based on the left image of the first reference stereoscopic image and the left image subjected to geometric deformation and synthesizing a right panorama image based on the right image of the first reference stereoscopic image and the right image subjected to geometric deformation;
a step of acquiring a representative disparity amount of the left panorama image and the right panorama image; and
a step of trimming images of an area having a mutually overlapping effective pixel, from each of the left panorama image and the right panorama image synthesized by the panorama synthesis unit,
wherein, in the step of trimming, determining and trimming trimming areas of the synthesized left panorama image and the synthesized right panorama image such that the representative disparity amount acquired in the representative disparity amount acquisition step is a preset disparity amount.

12. A stereoscopic panorama image synthesizing device comprising:
an image acquisition unit configured to acquire a plurality of stereoscopic images including left images and right images taken by a multi-eye imaging device, the left images and right images being taken in each imaging direction by changing a imaging direction of the multi-eye imaging device;
a storage unit configured to separate the left images and the right images from the plurality of acquired stereoscopic images and to store the left images and the right images separately;
a projective transformation unit configured to perform projective transform of the plurality of stored left images and right images onto an identical projection surface separately;
a corresponding point detection unit configured to detect a corresponding point in an overlapping area between the plurality of left images subjected to projective transform and to detect a corresponding point in an overlapping area between the plurality of right images subjected to projective transform;
a reference image setting unit configured to set a reference stereoscopic image among the plurality of stereoscopic images;
an image deformation unit configured, with reference to the left image and the right image subjected to projective transform in the set reference stereoscopic image, to perform geometric deformation of an adjacent left image such that the corresponding points detected by the corresponding point detection unit between the reference left image and the adjacent left image adjacent to it are matched, and to perform geometric deformation of an adjacent right image such that the corresponding points detected by the corresponding point detection unit between the reference right image and the adjacent right image adjacent to it are matched, wherein a stereoscopic image including the left image and the right image subjected to geometric deformation is set as a next reference stereoscopic image when there are the left image and the right image subjected to projective transform that are adjacent to the left image and the right image subjected to geometric deformation, and the left image and the right image subjected to projective transform are subjected to geometric deformation as above;
a panorama synthesis unit configured to synthesize a left panorama image based on the left image of the reference stereoscopic image and the left image subjected to geometric deformation and to synthesize a right panorama image based on the right image of the reference stereoscopic image and the right image subjected to geometric deformation;
a representative disparity amount acquisition unit configured to acquire a representative disparity amount of the left panorama image and the right panorama image; and
a trimming unit configured to trim images of an area having a mutually overlapping effective pixel, from each of the left panorama image and the right panorama image synthesized by the panorama synthesis unit,
wherein the trimming unit determines and trims trimming areas of the synthesized left panorama image and the synthesized right panorama image such that the representative disparity amount acquired by the representative disparity amount acquisition unit is a preset disparity amount.

13. The stereoscopic panorama image synthesizing device according to claim 12, further comprising
a main subject detection unit configured to detect a face as a main subject from the plurality of stereoscopic images acquired by the image acquisition unit,
wherein the reference image setting unit sets a stereoscopic image in which a number of faces is the largest or a stereoscopic image in which a size of the face is the largest as the reference stereoscopic image.

14. The stereoscopic panorama image synthesizing device according to claim 13,
wherein, in a case where the main subject has not been detected by the main subject detection unit, the reference image setting unit sets a stereoscopic image closest to a center in an imaging order among the plurality of stereoscopic images, as the reference stereoscopic image.

15. The stereoscopic panorama image synthesizing device according to claim 12,
wherein, at a time of synthesizing the left panorama image and the right panorama image, images of an overlapping area between adjacent images are subjected to weighted average and synthesized by the panorama synthesis unit.

16. The stereoscopic panorama image synthesizing device according to claim 12, further comprising
a recording unit configured to record, in a recording medium, the left panorama image and the right panorama image generated by the panorama synthesis unit in association with each other.

17. The stereoscopic panorama image synthesizing device according to claim 16,
wherein the recording unit records, in the recording medium, the representative disparity amounts acquired by the representative disparity amount acquisition unit in association with the left panorama image and the right panorama image.

18. The stereoscopic panorama image synthesizing device according to claim 17, further comprising
an output unit configured to output the left panorama image and the right panorama image recorded in association in the recording medium,
wherein the output unit relatively shifts pixels of the left panorama image and the right panorama image such that, based on the representative disparity amounts recorded in association with the left panorama image and the right panorama image, the representative disparity amounts match a preset disparity amount, and outputs the left panorama image and the right panorama image.

19. The stereoscopic panorama image synthesizing device according to claim 12,
wherein the representative disparity amount acquisition unit acquires the representative disparity amount based on the reference stereoscopic image set by the reference image setting unit.

20. The stereoscopic panorama image synthesizing device according to claim 12,
wherein the representative disparity amount acquisition unit comprises:
a corresponding point detection unit configured to detect a corresponding point per pixel of the left panorama image and the right panorama image;
a disparity amount calculation unit configured to calculate a disparity amount between the detected corresponding points;
a histogram creation unit configured to create a histogram of the disparity amounts calculated on a pixel-by-pixel basis; and
a representative disparity amount determination unit configured to determine a representative disparity amount based on the created histogram.

21. A multi-eye imaging device comprising:
a plurality of imaging units used as the image acquisition unit; and
the stereoscopic panorama image synthesizing device according to claim 12.

22. The multi-eye imaging device according to claim 21, further comprising:
a mode setting unit configured to set a stereoscopic panorama imaging mode; and
a control unit configured to fix, when the stereoscopic panorama imaging mode is selected, a focus position, an exposure condition and a white balance gain of a stereoscopic image taken in every imaging direction, to a value set at a time of taking a first image.

23. A stereoscopic panorama image synthesizing method comprising:
a step of acquiring a plurality of stereoscopic images including left images and right images taken by a multi-eye imaging device, the left images and right images being taken in each imaging direction by changing a imaging direction of the multi-eye imaging device;
a step of separating the left images and the right images from the plurality of acquired stereoscopic images and storing the left images and the right images separately;
a step of performing projective transform of the plurality of stored left images and right images onto an identical projection surface separately;
a corresponding point detecting step of detecting a corresponding point in an overlapping area between the plurality of left images subjected to projective transform and detecting a corresponding point in an overlapping area between the plurality of right images subjected to projective transform;
a step of setting a reference stereoscopic image among the plurality of stereoscopic images and setting a stereoscopic image, in which the main subject has been detected, as the reference stereoscopic image;
a step of, with reference to the left image and the right image subjected to projective transform in the set reference stereoscopic image, performing geometric deformation of an adjacent left image such that the corresponding points detected in the corresponding point detecting step between the reference left image and the adjacent left image adjacent to it are matched, and performing geometric deformation of an adjacent right image such that the corresponding points detected in the corresponding point detecting step between the reference right image and the adjacent right image adjacent to it are matched, wherein a stereoscopic image including the left image and the right image subjected to geometric deformation is set as a next reference stereoscopic image when there are the left image and the right image subjected to projective transform that are adjacent to the left image and the right image subjected to geometric deformation, and the left image and the right image subjected to projective transform are subjected to geometric deformation as above;
a step of synthesizing a left panorama image based on the left image of the reference stereoscopic image and the left image subjected to geometric deformation and synthesizing a right panorama image based on the right image of the reference stereoscopic image and the right image subjected to geometric deformation;
a step of acquiring a representative disparity amount of the left panorama image and the right panorama image; and
a step of trimming images of an area having a mutually overlapping effective pixel, from each of the left panorama image and the right panorama image synthesized by the panorama synthesis unit,
wherein, in the step of trimming, determining and trimming trimming areas of the synthesized left panorama image and the synthesized right panorama image such that the representative disparity amount acquired in the representative disparity amount acquisition step is a preset disparity amount.
